(19) United States
(12) Patent Application Publication
(10) Pub. No.: US 2007/0151397 A1
(43) Pub. Date: Jul. 5, 2007

(54) DEVICE AND METHOD FOR OPERATING A EJECTION MECHANISM

(75) Inventor: Klaus Heesen, Leonberg (DE)

Correspondence Address: BANNER & WITCOFF, LTD., 1100 13th STREET, N.W., SUITE 1200, WASHINGTON, DC, 20005-4051, US

(73) Assignee: HUSH TECHNOLOGIES INVESTMENTS LTD., London (GB)

(21) Appl. No.: 11/609,591

(22) Filed: Dec. 12, 2006

(30) Foreign Application Priority Data
Dec. 13, 2005 (DE) 20 2005 019 490.5

(51) Int. Cl. G05G 1/00

(52) U.S. Cl. 74/503

(57) ABSTRACT

A device for actuating a mechanism for ejecting a data carrier, particularly a DVD or CD, from a drive in a housing is provided. The drive comprises an actuator that is arranged within a portion of an area at the drive, wherein an operating element is provided at the housing, and wherein the operating element is coupled to the actuator in such a way that a force exerted upon the operating element is transmitted on the entire said area at the drive such that an operation of the operating element results in the actuation of the actuator regardless of in which portion of said area the actuator is located.

### CROSS REFERENCE TO RELATED APPLICATION

This application claims priority from German Patent Application No. 20 2005 019 490.5, filed Dec. 13, 2005, the entire contents of which are incorporated herein by reference.

### FIELD

The present invention pertains to a device for actuating a mechanism for ejecting a data carrier, particularly a DVD or CD, from a drive in a housing, for example, a computer housing.

### BACKGROUND

Electronic devices such as, for example, computers are assembled from numerous components that are frequently supplied by different manufacturers. The components are selected in dependence on various criteria, particularly capacity, price, assembly dimensions, etc.

Components frequently need to be adapted to one another. It may be necessary to adapt the housing in order to utilize components of certain manufacturers. For example, the ejection button provided on the housing for ejecting an optical data carrier (e.g., CD, DVD) from a drive arranged in the housing needs to be adapted to the position of the actuator on the drive. This either increases the expenditures for the design of housings suitable for accommodating drives of certain manufacturers, or limits the selection of drives of certain manufacturers.

### SUMMARY

The invention provides a device for actuating a mechanism for ejecting a data carrier, particularly a DVD or CD, from a drive in a housing, wherein the drive comprises an actuator that is arranged within a portion of an area at the drive, wherein an operating element is provided at the housing, and wherein the operating element is coupled to the actuator in such a way that a force exerted upon the operating element is transmitted on at least a portion of the area at the drive such that an operation of the operating element results in the actuation of the actuator regardless of in which portion of said area the actuator is located. In one arrangement, the force exerted on the operating element may be transmitted on the entire area at the drive.

This largely makes the positioning of the operating element independent of the location at which the actuator for ejecting the data carrier is arranged.

Consequently, it is possible to utilize different drives that feature differently arranged actuators without having to alter the arrangement of the operating element on the housing.

The operating element preferably is formed by a first push-button, wherein a force of pressure exerted upon the first push-button is transmitted on the entire area in order to activate the actuator, and wherein the actuator is formed by a second push-button. This means that a force of pressure exerted upon the first push-button is transmitted on the second push-button regardless of the arrangement of the first and the second push-button relative to one another as long as the second push-button is positioned within said area onto which a force of pressure exerted upon the first push-button is transmitted.

In one arrangement, the first push-button and the second push-button are arranged offset relative to one another in the direction of a force of pressure exerted upon the push-buttons and do not overlap one another. Consequently, the first push-button can be arranged in the housing in accordance with criteria that are largely independent of the installation of the drive in the housing. For example, the operating element may be arranged on the right or left edge of the front plate of the housing while the actuator of the drive is arranged centrally with reference to the front plate.

The first push-button preferably comprises a first portion that can be subjected by a user to a force of pressure on the front side of the housing, as well as a second portion that, due to the pressure exerted upon the first portion of the push-button, subjects the entire area on the drive to a force of pressure such that the actuator is actuated. The front side of the first portion of the first push-button that can be subjected to a force of pressure by a user has a smaller surface than the rear side of the second portion of the first push-button that subjects the entire area on the drive to a force of pressure. The area on the drive is preferably situated on the front side of the drive that faces the front plate of the housing, and the first push-button is preferably situated on the outer side of the front plate of the housing.

Consequently, a force of pressure exerted by a user upon a relatively small area, i.e., on the externally accessible first portion of the push-button, is transmitted on a relatively large area, i.e., on a correspondingly large area on the front side of the drive, by the rear side of the second portion of the push-button. The transmission of forces takes place in a purely mechanical fashion and therefore can be easily and inexpensively realized.

In one arrangement, at least one spring is provided between the rear side of the first push-button and the front side of the drive, wherein said spring, in the idle state, spaces apart the first push-button from the front side of the drive. This improves the operating sensation and also contributes to the mechanical and acoustical decoupling of the drive from the housing, as well as the decoupling of the drive from air-borne noise, structure-borne noise and vibrations.

At least two springs may be arranged between the rear side of the first push-button and the front side of the drive such that they abut the outer ends of the second portion of the first push-button. This additionally improves the operating sensation; in particular, the pressure sensation on the first push-button largely remains constant regardless of the location at which the second push-button is arranged relative to the first push-button.

The housing may furthermore comprise a receptacle for the drive with at least one spring that is arranged between the rear side of the drive and the receptacle which presses the drive against the inner side of the front plate of the housing.

This additionally improves the mechanical and acoustical decoupling of the drive from the housing, particularly the decoupling of the drive from air-borne noise, structure-borne noise and vibrations.

A damping arrangement may be provided between the rear side of the front plate and the front side of the drive. This additionally improves the mechanical and acoustical decoupling of the drive from the housing.

Thus, there is provided a new mechanism for ejecting optical data carriers that can be used with differently constructed drives and allows a decoupling of the drive from air-borne noise/structure-borne noise/vibrations without having to utilize specialty drive constructions for this purpose. The mechanism may be used in a variety of applications including computers and multimedia devices.

### BRIEF DESCRIPTION OF THE DRAWINGS

A more complete understanding of the present invention and at least some advantages thereof may be acquired by referring to the following description in consideration of the accompanying drawings, in which like reference numbers indicate like features, and wherein:

FIG. 1 illustrates individual components for assembling a device according to one arrangement described herein;

FIG. 2 illustrates a drive for use in a device according to one arrangement described herein, and

FIGS. 3-5 are schematic representations of the assembled individual components shown in FIG. 1.

### DETAILED DESCRIPTION

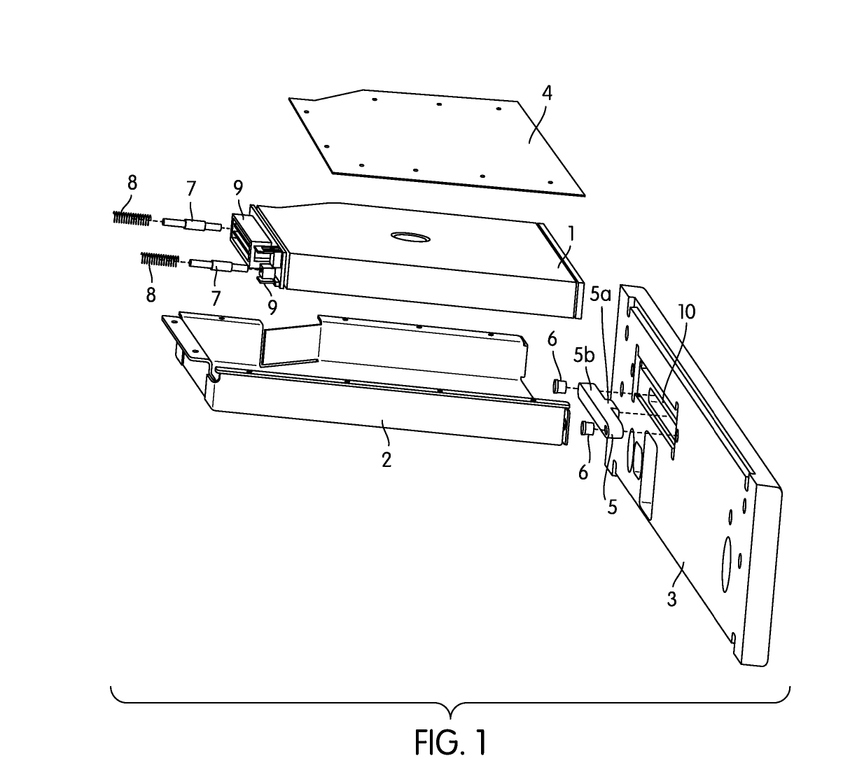

FIG. 1 shows elements of a device according to aspects of the device described herein. The reference symbol 1 identifies a drive, for instance an optical drive such as, e.g., a CD or DVD drive that is installed in a housing, for example, the housing of a computer. The reference symbol 2 identifies a base cradle for accommodating the drive to be installed in the housing. The reference symbol 3 identifies a front plate of the housing. The reference symbol 4 identifies a cover plate for covering the base cradle 2 with the drive 1 accommodated therein. The reference symbol 5 identifies an actuating strip for actuating the ejecting mechanism of the drive 1 as described in detail below. The reference symbol 6 identifies two spring elements that are arranged between the actuating strip 5 and the front side of the drive 1 to space apart the actuating button 5 from the front side of the drive 1 in their idle state. The reference symbols 7 and 8 identify set screws and pressure springs, respectively, for springably mounting the drive 1 in the base cradle 2. The reference symbol 9 identifies the circuit board adapter of the drive 1. The reference symbol 10 identifies an opening in the front plate 3, through which the actuating strip 5 extends to the front side of the housing, namely to a location where it can be subjected to a force of pressure by a user in order to actuate the ejecting mechanism of the drive 1.

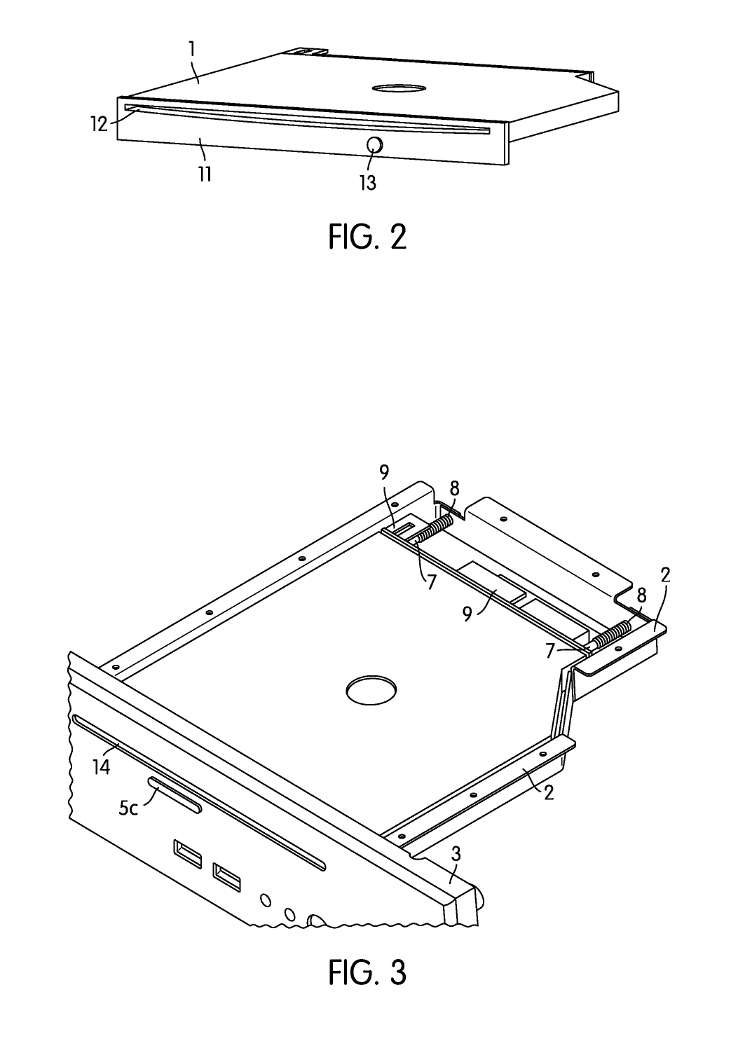

FIG. 2 shows the drive 1. The drive 1 features a front side 11 with a slot 12, through which an optical data carrier (e.g., a DVD, CD) can be inserted into the drive or ejected therefrom. An actuator 13 for ejecting the data carrier is arranged on the front side 11 and can be actuated by exerting a force of pressure thereupon.

With reference to FIGS. 2-5, during the assembly of the individual elements, the base cradle 2 is initially screwed to the front plate 3 of the housing. Subsequently, the spring elements 6 are inserted into corresponding bores 15 in the actuating strip 5. The actuating strip is then inserted into the opening 10 in the front plate 5 of the housing. Subsequently, the set screws 7 are screwed into the rear side of the drive 1. They also hold the circuit board adapter 9. The pressure springs 8 are pushed on the set screws 7.

This pre-assembled unit is now inserted into the base cradle 2 on the front side of the drive 1 for the installation into the computer housing. Subsequently, the pressure springs 8 are engaged into pocket holes provided in the base cradle 2 for this purpose. The pressure springs 8 press the drive 1 against the front plate 3. An intermediate damping arrangement of cellular rubber, caoutchouc or the like is preferably also provided between the drive 1 and the front plate 3 in order to achieve a superior decoupling.

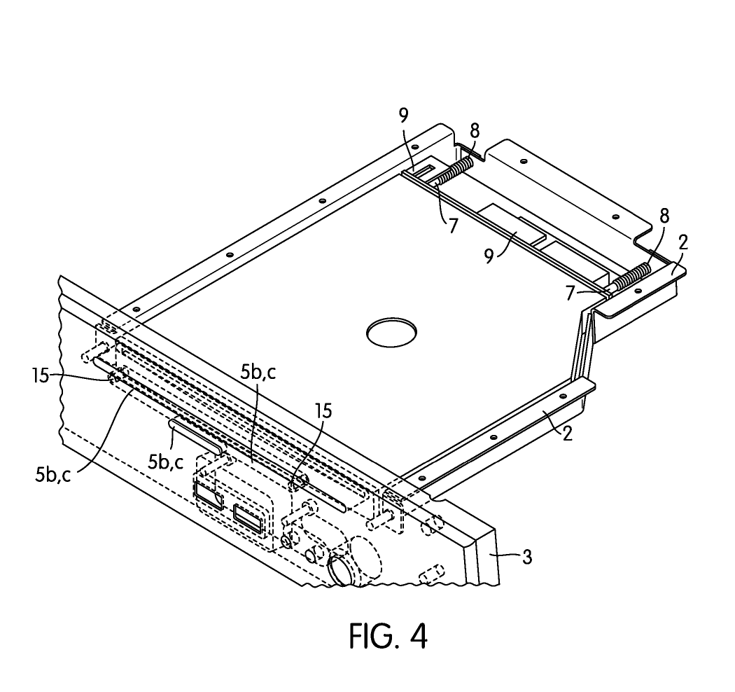

The actuating strip 5 consists of a first shorter portion 5a and a second longer portion 5b along the front plate 3 (see also FIG. 4). The first portion 5a forms a platform-like projection on the second portion 5b. The first portion 5a extends to the front side of the housing through the opening 10 in the front plate 3 such that it can be actuated by a user. The surface of the first portion 5a therefore forms a button 5c that can be subjected to a force of pressure by a user (see FIG. 3).

The longer second portion 5b extends on the inner side of the front plate 3. The bores for accommodating the spring elements 6 are provided on the two outer ends of the second portion 5b.

When the button 5c is subjected to pressure, the rear side of the actuating strip 5 (i.e., the rear surface of the second portion 5b) is pressed on the front side of the drive 1 against the force of the springs 6. This means that an area of the front side of the drive 1 that corresponds to the surface of the rear side of the actuating strip 5 (i.e., the rear surface of to second portion 5b) can be subjected to a force of pressure. Consequently, the actuator 13 situated within this area is actuated, regardless of the fact in which portion of this area the actuator 13 is arranged.

Since the position of the actuator varies depending on the manufacturer, this mechanism realized by means of the actuating strip 5 makes it possible to utilize drives 1 of different manufacturers without having to adapt the construction of the actuating mechanism or the housing.

The two spring elements 6 press the second portion 5b of the actuating strip 5 against the inner side of the front plate 3 without play in the idle state such that a uniform and simultaneous transmission of forces of pressure is provided by the actuating strip 5 onto the entire area of the front side of the drive. Consequently, a user is unable to sense where the actuator 13 of the drive 1 is arranged, i.e., whether the actuator 13 is situated, for example, directly behind the button 5c or offset relative to the button 5c.

FIG. 3 shows the drive 1 after the installation into the computer housing.

According to this figure, the front plate 3 also contains a slot 14 that extends in accordance with the slot 12 of the drive 1 such that a data carrier can be inserted into the drive 1 and ejected therefrom through the slots 12 and 14.

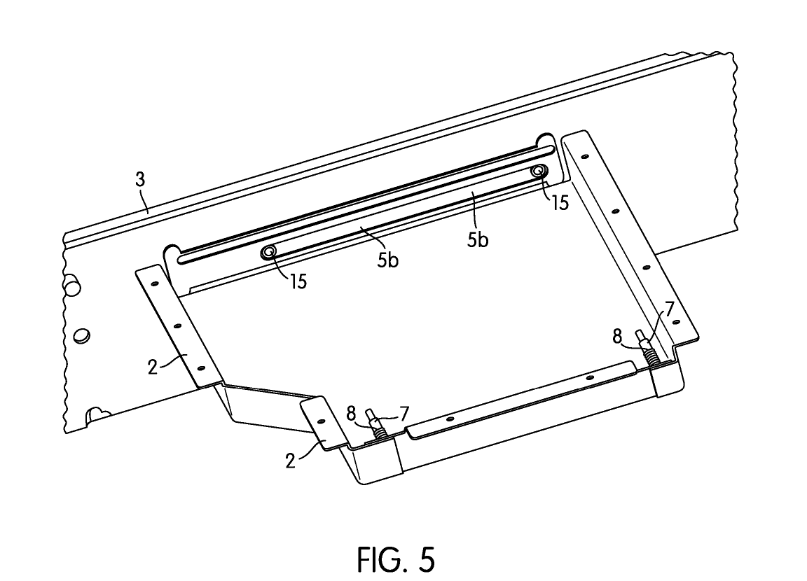

FIGS. 4 and 5 schematically show two different perspective representations of the installed device.

It must be noted that the described embodiment should be understood in an exemplary sense and that the scope of protection is defined by the claims.

1. A device for actuating a mechanism for ejecting a data carrier, particularly a DVD or CD, from a drive in a housing, comprising:
an actuator that is arranged within a portion of an area at the drive; and
an operating element is provided at the housing;
wherein the operating element is coupled to the actuator to transmit a force exerted upon the operating element to the entire area at the drive to provide an actuation of the actuator regardless of in which portion of said area the actuator is located.

2. The device according to claim 1, wherein the operating element is formed by a first push-button.

3. The device according to claim 2, wherein a force of pressure exerted upon the first push-button is transmitted to the entire area at the device to actuate the actuator.

4. The device according to claim 3, wherein the actuator is formed by a second push-button.

5. The device according to claim 4, wherein the first push-button and the second push-button are arranged offset relative to one another in the direction of a force of pressure exerted upon the push-buttons.

6. The device according to claim 5, wherein the first push-button and second push-button do not overlap one another.

7. The device according to claim 3, wherein the first push-button further includes a first portion that can be subjected by a user to a force of pressure on a front side of the housing, and a second portion that, in response to pressure exerted upon the first portion of the push-button, subjects the entire area at the drive to the force of pressure such that the actuator is actuated.

8. The device according to claim 7, wherein a front side of the first portion of the first push-button that can be subjected to a force of pressure by a user has a smaller surface than a rear side of the second portion of the first push-button that can subject the entire area on the drive to a force of pressure.

9. The device according to claim 3, wherein said area at the drive is situated on a front side of the drive that faces a front plate of the housing.

10. The device according to claim 9, wherein the first push-button is situated on an outer side of the front plate of the housing.

11. The device according to claim 9, wherein at least one spring is provided between a rear side of the first push-button and a front side of the drive.

12. The device according to claim 11 wherein the at least one spring spaces apart the first push-button from the front side of the drive in an idle state.

13. The device according to claim 8, wherein at least two springs are arranged between the rear side of the first push-button and the front side of the drive.

14. The device according to claim 13, wherein the at least two springs abut outer ends of the second portion of the first push-button.

15. The device according to claim 1, wherein the housing comprises a receptacle for the drive with at least one spring that is arranged between the rear side of the drive and the receptacle which presses the drive against the inner side of the front plate of the housing.

16. The device according to claim 15, wherein a damping arrangement is provided between the rear side of the front plate and the front side of the drive.

17. A multimedia device, comprising:
a housing;
a drive arranged within the housing; and
a device, the device comprising:
an actuator that is arranged within a portion of an area at the drive; and
an operating element is provided at the housing;
wherein the operating element is coupled to the actuator to transmit a force exerted upon the operating element to the entire area at the drive to provide an actuation of the actuator regardless of in which portion of said area the actuator is located.

18. The multimedia device according to claim 17, wherein the operating element includes a first push-button.

19. A device for actuating a mechanism for ejecting a data carrier from a drive in a housing, comprising:
an actuator strip arranged within a portion of an area at the drive and including a first portion that extends through the housing and a second portion, connected to the first portion, that contacts an area on a front side of the drive in an activated mode; and
at least one spring provided between the actuator strip and a front side of the housing, wherein the at least one spring maintains a gap between the actuator strip and the front side of the drive in an idle mode;

20. The device according to claim 19, wherein the first portion of the actuator strip is a push-button.
